(19) United States
(12) Patent Application Publication
(10) Pub. No.: US 2004/0016161 A1
(43) Pub. Date: Jan. 29, 2004

(54) Flat or curved signage system

(76) Inventor: Erik Broos-Godts, Diest (BE)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/207,721

(22) Filed: Jul. 29, 2002

(51) Int. Cl. G09F 3/20

(52) U.S. Cl. 40/611.12; 40/658

(57) ABSTRACT

The present invention describes a sign system (1) which comprises a sign side support element (2), a plurality of clipping means (5) provided with clipping legs (8), and at least one sign plate (16) for being clipped on the clipping legs (8). The clipping means (5) form a hinging connection with the sign support element (2). The clipping means (5) may therefor be provided with a protruding member (9) co-operating with a tubular slot (4) in the side support element (2).

### TECHNICAL FIELD OF THE INVENTION

The present invention relates to flat or curved signage systems, more particularly to signage systems of a type in which sign plates are clipped onto clipping members.

### BACKGROUND OF THE INVENTION

Indoor sign systems are widely used in a large number of applications, including offices, hospitals, etc. Such sign systems may include the direction towards different departments or rooms, the identity of persons residing in a room, as well as listings of doctors, personnel, and names of persons in an old people's home for example, as well as the locations where they can be found. A range of types of signs may be desirable, e.g. going from signs indicating a single title or a single name, signs indicating both a name and a title, to signs indicating a whole directory of names and/or locations.

It is known to use curved sign systems. They have one or a plurality of curved sign plates, the curved sign plates generally being curved profiles with protruding members at their back side for co-operating with dedicated fastening members. The dedicated fastening members are different for each other curvature of the profiles. The curved profiles may also have protruding members at their front side, for receiving a sliding insertion of a separate inscribed plate. If not, the curved profiles allow lettering on their front face.

A disadvantage of the known curved sign system is that there does not exist a modular curved sign system. Different fastening members and/or different protruding members at the curved sign plates are to be provided in order to cope with different curvatures of the sign plates.

It is an aim of the present invention to provide an improved flat or curved signage system, which is easy to mount, and which is modular in that the same clipping members can be used for different curvatures of the sign plates.

### SUMMARY OF THE INVENTION

The above objectives are accomplished by a signage system according to the present invention comprising a sign side support element, a plurality of clipping means provided with clipping legs, and at least one sign plate for being clipped on the clipping legs, wherein the clipping means form a hinged connection with the sign support element. The clipping means may be provided with a protruding member which engages with a tubular slot in the sign support element for forming the hinged connection. The protruding member may be substantially cylindrical. Furthermore a cover plate may be provided for closing off top and/or bottom of the sign support element. The sign plates may be curved.

The present invention also provides a kit comprising a signage system as described above and a tool for setting the angular orientation of the clipping means about a hinge point with respect to the sign support element.

The present invention also provides a method for mounting a sign system, comprising the steps of:

forming a hinged connection between clipping means and a sign side support element, and

attaching at least one sign plate to the clipping means.

The attaching of a sign plate may be done by clipping protruding holding members of the sign plate onto corresponding clipping legs protruding from the clipping means. Before attaching the sign plate to the clipping means, the clipping means may be rotated about a hinge point in relation to the sign support element. The orientation of the clipping means may be set by locating a tool between a back portion of the clipping means and a back plate of the sign support element or a bearing substrate onto which the sign support element has been connected. Such a tool may for example be a wedge of suitable dimensions depending on the curvature of the sign plates, which is fixed, e.g. by screwing or gluing, between the back portion of the clipping means and the back plate of the sign support element or the bearing substrate. Such a fixed tool allows to change one or all of the sign plates later on. According to another embodiment, the tool can be a lath which is removably put between the back portion of the clipping means an the back plate of the sign support or the bearing substrate before attaching the sign plates onto the clipping means. The width of the lath used depends on the curvature of the sign plates used.

Other features and advantages of the present invention will become apparent from the following detailed description, taken in conjunction with the accompanying drawings, which illustrate, by way of example, the principles of the invention.

### BRIEF DESCRIPTION OF THE DRAWINGS

FIG. 1 is a top view of a curved sign system according to a first embodiment of the present invention, which sign system comprises a side wall, clipping means and a sign plate.

FIG. 2 is a top view of a curved sign system according to a second embodiment of the present invention, which sign system comprises a side wall, clipping means and a sign plate.

FIG. 3 is a detailed view of the clipping means according to an embodiment of the present invention, FIG. 3A being a front view, FIG. 3B being a side view according to B-B′ in FIG. 3A and FIG. 3C being a top view according to C-C′ in FIG. 3A.

FIG. 4 shows a vertical cross-section of a plurality of sign plates which may be used for making a sign system according to the present invention.

FIG. 5 shows a vertical cross-section of series of clipping means onto which different embodiments of sign plates have been clipped.

FIG. 6 is a top view of a back to back sign system with curved sign plates according to a further embodiment of the present invention.

In the different figures, the same reference numbers refer to the same or analogous elements.

### DESCRIPTION OF THE ILLUSTRATIVE EMBODIMENTS

The present invention will be described with respect to particular embodiments and with reference to certain drawings but the invention is not limited thereto but only by the claims. The drawings described are only schematic and are non-limiting. An arbitrary Cartesian reference co-ordinate system is shown in the drawings which is merely used for clarity purposes.

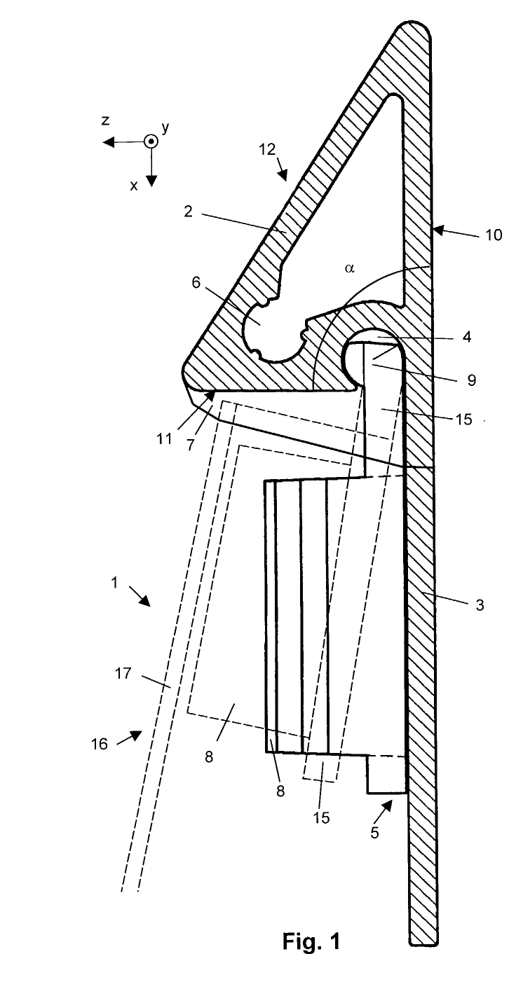

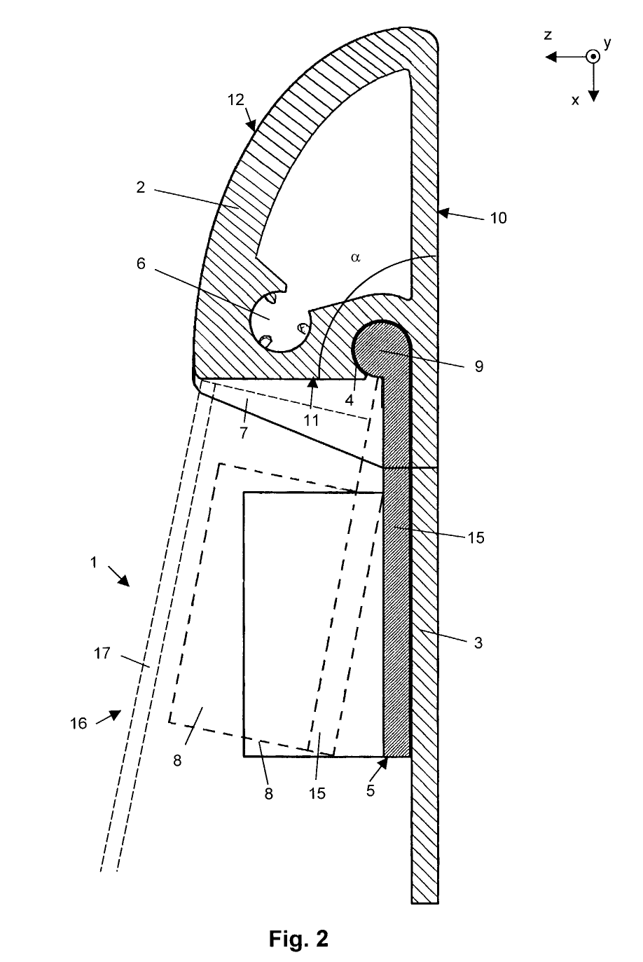

FIG. 1 and FIG. 2 each show a top view of part of two embodiments of a signage system 1 for being fixed against a carrying or support substrate according to the present invention. Preferably, the signage system 1 comprises two symmetrical side walls 2, one at each side of the sign system in the x-direction, of which only one is represented in FIG. 1 and in FIG. 2. The side walls 2 may be, in cross-section, substantially triangular, as represented in FIG. 1, or rectangular, or they may have substantially the form of an arcuate, circular or oval segment, as represented schematically in FIG. 2, or they may have any other suitable form in cross-section. A suitable form in horizontal cross-section has a back face 10 which fits against the bearing or carrying substrate such as e.g. a wall (not represented). It has a first side face 11 preferably perpendicular to the back face 10, or including an angle α with the back face 10 which is not substantially larger than 90°. The cross-section furthermore has a further face 12, which may be a single flat face, a single curved face, or may comprise a plurality of flat or curved faces, or a combination of flat and curved faces. In FIG. 1, the further face 12 is a single flat face. In FIG. 2, the further face 12 is a single curved face. In case of a side wall 2 with a substantially rectangular cross-section (not represented), the rectangle of the rectangular cross-section comprises four faces: a back face, a first side face perpendicular to the back face, a front face and a second side face. The front face and the second side face together form the further face 12.

The further face 12 is usually decorative and contributes to the outer appearance of the signage system 1.

The side walls 2 are preferably made from a rigid material. They are preferably shaped in such a manner that they can be made by extrusion without excessive post-processing, e.g. only requiring cutting to length and de-burring if necessary. The desired length to which the side walls 2 are cut, typically corresponds to the height of the sign system 1. The profiles of the side walls 2 may be hollow, as represented in FIG. 1 and in FIG. 2, or filled (not represented). Preferably, a hole 6 is provided in the side walls 2, in which a screw fits for fixing a cover plate 7 at the top and at the bottom of the sign system 1.

In the embodiments shown in FIG. 1 and FIG. 2, the side wall 2 forms a unitary part with a back plate 3 which is intended to be fixed onto a supporting or carrying substrate. This substrate may be a fixed substrate such as e.g. a door or a wall, or it may be a back plate of another sign system so as to mount back to back sign systems. The back plate 3 may be fixed onto the carrying substrate by screwing, gluing, welding, or in any other suitable way known by a person skilled in the art.

The side wall 2 is provided with a longitudinal tubular slot 4 over its whole length. For a back plate 3 lying in an xy-plane as shown in FIGS. 1 and 2, the tubular slot 4 extends in the y-direction.

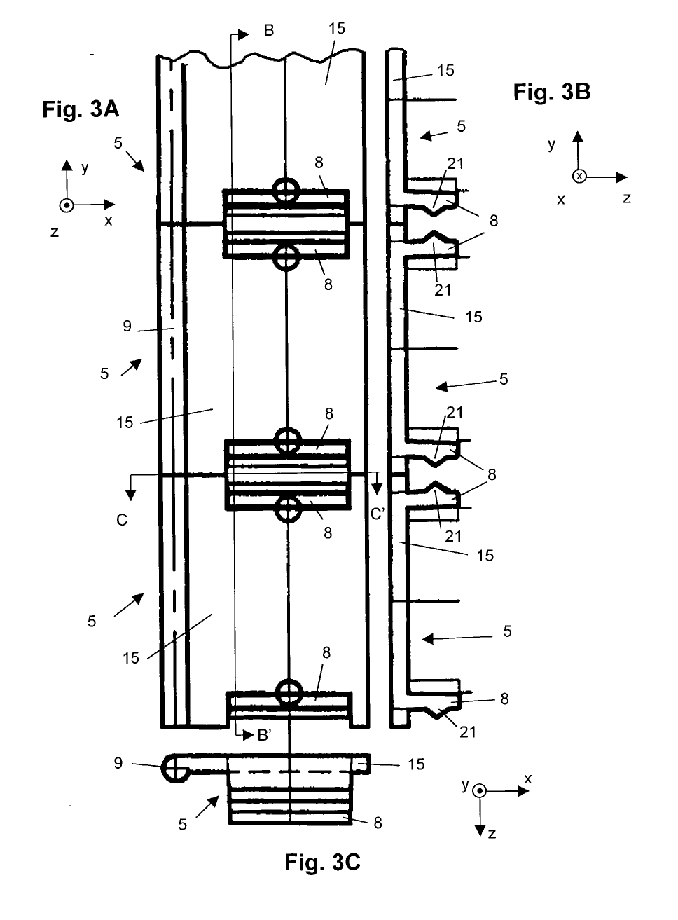

FIG. 3A shows a plurality of clipping means 5 according to the present invention, each provided with clipping legs 8. The clipping means 5 will typically be made of plastic by injection moulding or, for instance of aluminium by die casting. The clipping means 5 are adapted for supporting a sign plate 16. The clipping legs 8 are preferably made from a flexible material, such as a plastic, so that they can develop a clipping action for holding a sign plate.

According to the present invention, the clipping means 5 are provided with a protruding hinge member 9 which can be brought in engaging contact with the tubular slot 4 of a side wall 2 in order to form a hinging connection between the side wall 2 and the clipping means 5. Preferably, the protruding hinge member 9 is cylindrical, as shown in FIG. 2, or substantially cylindrical, as shown in FIG. 1. The protruding hinge member 9 may have an other form in cross-section, as long as it can form a hinging connection with the tubular slot 4 in the side wall 9. An advantage of the embodiment represented in FIG. 1 over the embodiment represented in FIG. 2, is that the cooperation of hinge member 9 with tubular slot 4 causes less friction because a smaller part of the outer surface of the hinge member 9 is in contact with the inner surface of the tubular slot 4. According to a further embodiment, not represented, the hinge member 9 or the tubular slot 4 could be provided with longitudinal grooves in the y-direction, over its whole length or only over part of its length. Other embodiments reducing the contacting surfaces of the hinge member 9 and the tubular slot 4 can also be used.

Preferably, the longitudinal axis of the protruding hinge member 9 extends over the whole longitudinal direction of the clipping means 5 (i.e. the y-direction if the clipping means is lying in an xy-plane as shown in FIG. 3A), although it may extend over only part of it (not represented). The protruding hinge member may slide into the receiving tubular slot 4 or be clipped into this. Also although in the embodiments of the present invention the clipping means 5 is provided with a protruding rod-like member 9 which locates in the slot 4, the clipping means 5 may be provided with the slot 4 and the side wall 2 may be provided with the protruding hinge member 9. Important is that the clipping means 5 and the side wall 2 co-operate to form a hinge.

FIG. 3B shows a vertical cross-section of the plurality of clipping means 5 and the clipping legs 8, according to the line B-B′ in FIG. 3A. A clipping means 5 comprises a substantially flat back portion 15 lying in an xy-plane. Clipping legs 8 are protruding from the flat back portion 15, lying in an xz-plane and extending substantially in the z-direction, at one side of the back portion 15 (i.e. in the positive z-direction only).

FIG. 3C is a horizontal cross-sectional view of a clipping means 5 with clipping leg 8 and with a cylindrical protruding member 9 according to the present invention.

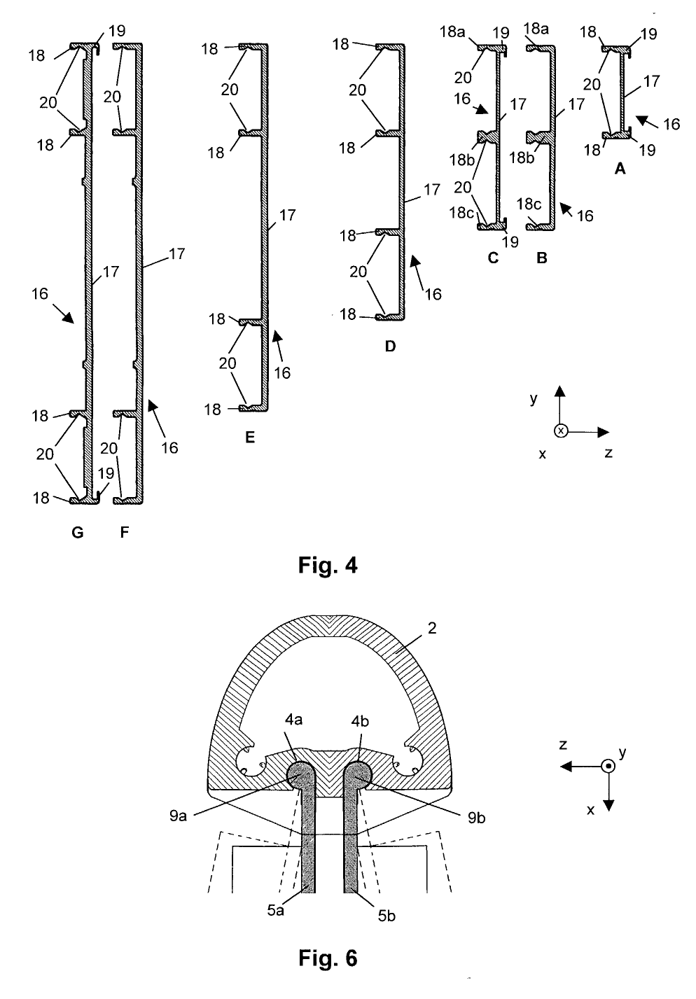

FIG. 4 shows different embodiments of sign plates 16. Each sign plate 16 comprises a sign face 17, the intersection of which with an xz-plane may be a straight or a curved line according to the present invention, and at least two holding members 18 for being clipped onto clipping legs 8 of clipping means 5. The holding members 18 preferably protrude from the sign face 17 perpendicularly thereto, so that in cross-section the sign face 17 lies in the y-direction, and the holding members protrude in the z-direction.

The sign plates 16 are preferably shaped in such a manner that they can be made by extrusion without excessive post-processing, e.g. only requiring bending, cutting to length and de-burring if necessary. The sign plates 16 are preferably made of a rigid material such as a metal, e.g. aluminium. Such sign 16 plates may be in the form of a channel with a plurality of longitudinally extending molding members 18, e.g. three members 18a, 18b, 18c in embodiment B of FIG. 4, which may extend over the whole length of the sign plate 16, or only over part of it. They may also extend substantially perpendicularly to a substantially flat or suitably shaped base plate which forms the main surface area for signage. For instance, the two outer members 18a, 18c may form one surface of the completed signage device. Such sign plates 16 can be made from aluminium by extrusion. A front signage face 17 of the sign plate 16 may be flat and lying substantially in an xy-plane, or it may be curved, and the three members lie in an xz-plane. The sign plates 16 clip with their holding members 18 onto the clipping legs 8 of the clipping means 5 in a retaining manner for the sign plate 16.

Embodiment A in FIG. 4 shows the smallest (in height) sign plate 16 possible for use with a certain type of clipping means 5. The height of the smallest type of sign plate depends on the distance between two clipping legs 8 on a clipping means 5. Furthermore, the sign plate 16 comprises protruding arms 19, which protrude from the sign face 17, at a side in the z-direction opposite the side from which the holding members 18 protrude, and which are used to receive a sliding insertion of a separate inscribed plate.

Embodiments B and C in FIG. 4 show two sign plates 16 with a height equal to twice the smallest height. Embodiment B shows a sign plate 16 which can bear lettering directly on its sign face 17, and embodiment C shows a sign plate 16 with protruding arms for receiving a sliding insertion of a separate inscribed plate. Both embodiments B and C have three holding members 18a, 18b, 18c for co-operating with clipping legs 8 of clipping means 5.

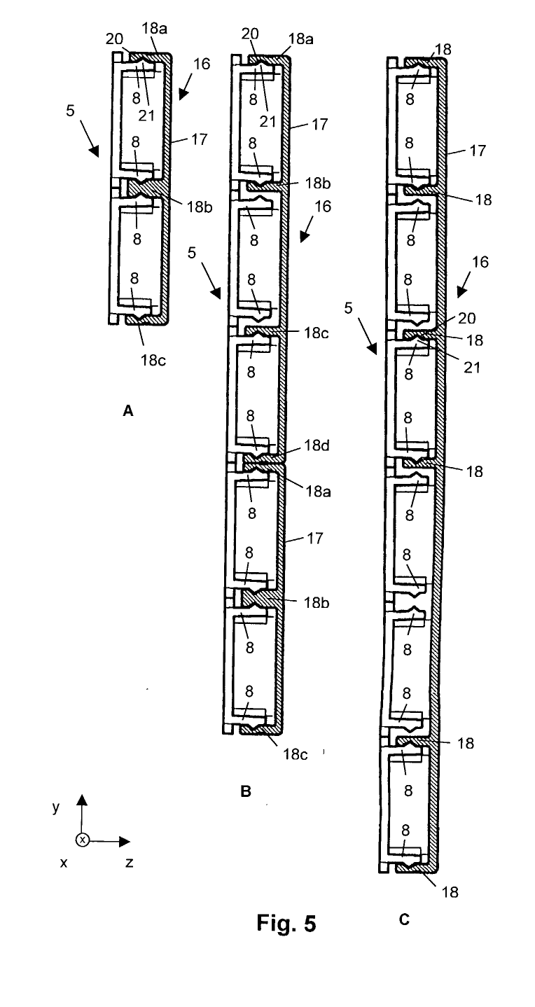

Embodiments D and E in FIG. 5 respectively show sign plates 16 which have a height equal to three and four times the smallest possible height. Both embodiments are provided for receiving direct lettering on the sign face 17. Alternative embodiments (not represented) could as well be provided with protruding arms for receiving a sliding insertion of a separate inscribed plate. Both embodiments shown have four holding members 18 for engaging with clipping legs 8 of clipping means 5.

Embodiments F and G in FIG. 5 respectively show sign plates 16 which have a height equal to five times the smallest possible height. Embodiment F is provided for receiving direct lettering on the sign face 17, and embodiment G is provided with protruding arms 19 for receiving a sliding insertion of a separate inscribed plate. Both embodiments have four holding members 18 for co-operating with clipping legs 8 of clipping means 5. In an alternative embodiment, they could have another number of holding members.

FIG. 5 shows a vertical cross-sectional view of different embodiments of clipping means 5 according to the present invention onto which sign plates 16 have been clipped. Holding members 18 co-operate with corresponding clipping legs 8 of the clipping means 5. Preferably the clipping legs 8 and the holding members 18 have engaging parts which mutually interfere with each other and engage each other such as to resist unclipping forces exerted on the sing plates 16 to a certain extent. The engaging parts represented in FIG. 5 are grooves 20 in the holding members 18 cooperating with ridges 21 on the clipping legs 8 to prevent removal of a sign plate 16 in the z-direction without exertion of enough force to make the ridges 21 ride out of the grooves 20 by deformation of the clipping legs 8. Other interfering forms and shapes are known to a person skilled in the art, and are included within the scope of the present invention, and may be used interchangeably with the described items.

Two clipping legs 8 may be pushed between two holding members 18, as shown in FIG. 5, the holding members 18 thus exerting a force on the respective clipping legs so that they are pushed towards each other. Alternatively, two holding members might be pushed between two clipping legs (not represented), the holding members thus exerting a force on the respective clipping legs so that they are pushed away from each other.

In embodiment A of FIG. 5, a single sign plate 16 with three protruding holding members 18a, 18b, 18c is clipped onto a plurality of clipping means 5. In embodiment B, two sign plates 16 are clipped onto a plurality of clipping means 5, a first sign plate having four protruding holding members 18a, 18b, 18c, 18d and a second sign plate having three protruding holding members 18a, 18b, 18c. In embodiment C, one sign plate 16 having six protruding holding members 18, is clipped onto a plurality of clipping means. The number and the format of the sign plates 16 clipped onto clipping means 5 depends on what exactly is desired from the sign system 1.

In order to mount a flat or curved sign system 1 according to the present invention, first of all two side walls 2 are cut to a desired length, which corresponds to the desired height of the sign system 1. A cover plate 7 is fixed at the bottom side of both side walls 2, e.g. by screwing a screw through the cover plate into hole 6.

The two side walls 2 may then be connected on a carrying substrate such as a wall, by screwing, gluing, welding or in any other suitable manner, at an adequate height and so that there is a distance between the first side face 11 of both side walls which equals the desired width of the sign system 1.

A plurality of clipping means 5, as described in FIG. 3, is then introduced with their protruding member 9 into the tubular slot 4 of each of the side walls 2, so that clipping means 5 with clipping legs 8 are present over the whole desired height of the sign system 1. The plurality of clipping means 5 may be a plurality of separate clipping means 5, each clipping means 5 having two protruding clipping legs 8, but it preferably is a series of clipping means 5 which are made in one piece, and which are cut to the desired length. By introducing the protruding member 9 into the tubular slot 4 of a side wall 2, a hinging connection is obtained between the clipping means 5 and said side wall 2.

If need be—when mounting curved sign plates 16—the clipping means 5 may be hinged with relation to the side wall 2 with which it engages, in order to enable clicking of the holding members 18 of the sign plates 16 onto clipping legs 8 of the clipping means 5. This hinging may be done e.g. by putting a tool between the back plate 3 of the side wall 2 and the back portion 15 of the clipping means 5. The hinged position is as shown in dotted lines in FIG. 1 and in FIG. 2. How much the clipping means 5 need be hinged with relation to the side walls 2, depends on the curvature of the sign plates 16 used. For flat sign plates 16, no hinging at all is necessary. It is a specific advantage of the present invention that the orientation of the clipping means may be adapted by means of a hinge to conform to the angle of the sign plate. This provides a more reliable attachment of the clipping means with the sign plate even where various curvatures of the sign plates are used. At the same time, the constructional details of the complete system have been optimised for extrusion of the main components and therefore for low manufacturing/high throughput.

It is to be understood that although specific constructions and configurations, as well as materials, have been discussed herein for devices according to the present invention, deviations can be made therein without departing from the spirit and scope of the present invention. For example, one side wall 2 could be provided with two tubular slots 4a, 4b next to each other, as represented in FIG. 6, so as to allow two series of clipping means 5a, 5b to be introduced back to back with their protruding member 9a, 9b each in one of the tubular slots 4a, 4b. That way, two curved or flat signage systems back to back can be mounted.

1.- A signage system (1) comprising a sign side support element (2), a plurality of clipping means (5) provided with clipping legs (8), and at least one sign plate (16) for being clipped on the clipping legs (8), wherein the clipping means (5) form a hinged connection with the sign support element (2).

2.- A sign system (1) according to claim 1, wherein the clipping means (5) are provided with a protruding member (9) which engages with a tubular slot (4) in the sign support element (2) for forming the hinged connection.

3.- A sign system (1) according to claim 2, wherein the protruding member (9) is substantially cylindrical.

4.- A sign system (1) according to claim 1, furthermore comprising a cover plate (7) for closing off top and/or bottom of the sign support element (2).

5.- A sign system (1) according to claim 4, furthermore comprising a screw for fixing the cover plate (7) on top and/or bottom of the sign support element (2).

6.- A sign system (1) according to claim 1, wherein the sign plates (16) are curved.

7.- A kit comprising a signage system (1) having a sign side support element (2), a plurality of clipping means (5) provided with clipping legs (8), and at least one sign plate (16) for being clipped on the clipping legs (8), wherein the clipping means (5) form a hinged connection with the sign support element (2), and a tool for setting the angular orientation of the clipping means (5) about a hinge point with respect to the sign support element (2).

8.- A kit according to claim 7, wherein the clipping means (5) are provided with a protruding member (9) which engages with a tubular slot (4) in the sign support element (2) for forming the hinged connection.

9.- A kit according to claim 8, wherein the protruding member (9) is substantially cylindrical.

10.- A kit according to claim 7, furthermore comprising a cover plate (7) for closing off top and/or bottom of the sign support element (2).

11.- A kit according to claim 10, furthermore comprising a screw for fixing the cover plate (7) on top and/or bottom of the sign support element (2).

12.- A kit according to claim 7, wherein the sign plates (16) are curved.

13.- Method for mounting a sign system (1), comprising the steps of:
forming a hinged connection between clipping means (5) and a sign side support element (2), and
attaching at least one sign plate (16) to the clipping means (5).

14.- Method according to claim 13, wherein the attaching of a sign plate (16) is done by clipping protruding holding members (18) of the sign plate (16) onto corresponding clipping legs (8) protruding from the clipping means (5).

15.- Method according to claim 13, wherein, before attaching the sign plate (16) to the clipping means (5), an orientation of the clipping means is set in relation to the sign support element (2).

16.- Method according to claim 15, further comprising the step of setting the orientation of the clipping means (5) by putting a tool between a back portion (15) of the clipping means (5) and a back plate of the sign support element (2) or a bearing substrate onto which the sign support element (2) has been connected.

17.- Method according to claim 13, furthermore comprising a step of fixing a cover plate (7) on top and/or bottom of the sign support element (2) for closing it off.

18.- Method according to claim 17, wherein the cover plate (7) is screwed on top and/or bottom of the sign support element (2).
